(19) United States
(12) Patent Application Publication
(10) Pub. No.: US 2022/0093950 A1
(43) Pub. Date: Mar. 24, 2022

(54) SOLID OXIDE FUEL CELL ARRANGEMENT GENERATING AMMONIA AS BYPRODUCT AND UTILIZING AMMONIA AS SECONDARY FUEL

(71) Applicant: ARIEL UNIVERSITY OF SAMARIA, Ariel (IL)

(72) Inventors: Valentina GOLDSTEIN, Petach Tikva (IL); Alexey KOSSENKO, Ashdod (IL); Aleksandr SOBOLEV, Ariel (IL); Michael ZINIGRAD, Ramat Gan (IL)

(21) Appl. No.: 17/420,369

(22) PCT Filed: Sep. 18, 2019
(86) PCT No.: PCT/IL2019/051035

§ 371 Date: Jul. 1, 2021

Related U.S. Application Data
(60) Provisional application No. 62/787,387, filed on Jan. 2, 2019.

(51) Int. Cl. H01M 8/0612; H01M 8/0662; H01M 8/04119; H01M 8/1213; C01C 1/12; C01B 3/36

(52) U.S. Cl. CPC H01M 8/0618; H01M 8/0687; H01M 8/04126; H01M 2008/1293; C01C 1/12; C01B 3/36; H01M 8/1213

(57) ABSTRACT

A high-temperature solid oxide fuel cell arrangement fueled by a hydrogen or hydrocarbon fuel and generating electricity and anunonia as a byproduct comprises: (a) a cathode area fed with a humid air; (b) an anode area fed with the fuel; and (c) an oxygen-conducting electrolyte disposed between the cathode and anode areas. The cathode has an ammonia-rich tail-gas stream. The fuel cell further comprises a gas separator configured for separating ammonia generated on the cathode from tail-gas stream and means for utilizing separated ammonia selected from the group consisting of: an ammonia reformer configured for generating hydrogen to be admixed to the fuel fed to the anode, a collecting tank for storing the anunonia and an auxiliary solid oxide fuel cell fueled by the separated anunonia and any combination thereof.

### FIELD OF THE INVENTION

The present invention relates to fuel cells and, more particularly, high-temperature solid oxide fuel cells to generate electricity and ammonia as byproduct available for further use.

### BACKGROUND OF THE INVENTION

Fuel cells are electrochemical devices which convert chemical energy of fuel and an oxidizing agent into electricity. Hydrogen or substances that include hydrogen are used as fuel in fuel cells. The fuel cells where ammonia is directly fed to an anode of the fuel cell are known in the art (see, for example U.S. Pat. No. 7,157,166). An alternative technical solution concerns the fuel cells fueled by hydrogen generated in decomposition of ammonia fuel into hydrogen and nitrogen (U.S. Pat. No. 3,532,547).

U.S. Pat. No. 8,034,499 discloses an energy conversion system comprising ammonia for fueling an SOFC stack to generate electricity and a hydrogen-rich tailgas. In the SOFC stack, ammonia is cracked to hydrogen and nitrogen. Ammonia is stored in a metal halide complex and is released therefrom as gaseous ammonia by waste heat from the SOFC. A heat exchanger is positioned across the SOFC cathode such that incoming air is tempered by the cathode exhaust air. In a two-stage energy conversion system, the hydrogen-rich tailgas from the SOFC is supplied as fuel to a secondary energy conversion device which may be, for example, an internal combustion engine or a gas turbine engine which may operate, for example, either a generator for generating additional electricity or a vehicle for motive power, or a second fuel cell stack.

There is a long-felt need of further efficiency enhancement of high-temperature solid oxide fuel cells fed with hydrogen or hydrocarbon fuels by providing a device and a method enabling utilization of ammonia generated as a byproduct by the aforesaid fuel cells.

### SUMMARY OF THE INVENTION

Briefly, energy conversional system, that include a solid oxide fuel cell stack to generate electricity and ammonia gas as byproduct that fueling a second energy conversion device such as other fuel cell or different using.

The aforesaid solid oxide fuel cell comprises: (a) an anode area fed with the hydrogen or hydrocarbon fuel; (b) a cathode area fed with a humid air; (c) an oxygen-conducting electrolyte disposed between the cathode and anode areas.

It is a core purpose of the invention to provide the cathode area has an ammonia-rich tail-gas stream. The fuel cell further comprises a gas separator configured for separating ammonia generated on the cathode from tail-gas stream and means for utilizing separated ammonia selected from the group consisting of: an ammonia reformer configured for generating hydrogen to be admixed to the fuel fed to the anode, a collecting tank for storing the ammonia and an auxiliary solid oxide fuel cell fueled by the separated ammonia and any combination thereof.

A further object of the invention is to disclose the fuel cell comprising heat transfer means configured to transfer heat generated by the fuel cell to the ammonia gas separator. A further object of the invention is to disclose the gas separator alternatively comprising:
an ammonia absorber, an ammonia evaporator and a dephlegmator; said evaporator is heated by heat generated by an electrochemical reaction between cathode and anode transferred to said evaporator.
a compressor and a membrane arrangement. The compressor configured for pumping said tail-gasses via said membrane arrangement such that ammonia is separated from other exhausted gases.
a compressor configured for pressurizing the tail-gases such that ammonia is liquefied while other constituents of the tail-gases are exhausted to the atmosphere.

A further object of the invention is to disclose a method of generating ammonia as a byproduct by a high-temperature solid oxide fuel cell arrangement fueled by a hydrogen or hydrocarbon fuel. The aforesaid method comprises steps of: (a) providing a high-temperature solid oxide fuel cell arrangement comprising: (i) a cathode area fed with a humid air; (ii) an anode area fed with the fuel; (iii) an oxygen-conducting electrolyte disposed between the cathode and anode areas; the cathode has an ammonia-rich tail-gas stream; the fuel cell further comprises a gas separator configured for separating ammonia generated on the cathode from tail-gas stream and means for utilizing separated ammonia selected from the group consisting of: an ammonia reformer configured for generating hydrogen to be admixed to the fuel fed to the anode, a collecting tank for storing the ammonia and an auxiliary solid oxide fuel cell fueled by the separated ammonia and any combination thereof; (b) feeding the fuel to the anode area; (c) feeding humid air to the cathode area; (d) operating the fuel cell; (e) generating the ammonia as a byproduct in the cathode area; (f) separating the ammonia from the tail-gas stream; and (g) utilizing separated ammonia by at least one way selected from the group consisting of reforming ammonia to hydrogen, storing ammonia in the collecting tank and fueling an auxiliary fuel cell.

### BRIEF DESCRIPTION OF THE DRAWINGS

In order to understand the invention and to see how it may be implemented in practice, a plurality of embodiments is adapted to now be described, by way of non-limiting example only, with reference to the accompanying drawings, in which:

FIG. 1 is a schematic diagram of a high-temperature solid oxide fuel cell arrangement provided with an ammonia reformer;

FIG. 2 is a schematic diagram of a high-temperature solid oxide fuel cell arrangement provided with an ammonia collecting tank;

FIG. 3 is a schematic diagram of a high-temperature solid oxide fuel cell arrangement provided with an ammonia-fueled secondary energy conversion device in accordance with the present invention;

FIG. 4 is a detailed schematic diagram of a dephlegmator-based separator;

FIG. 5 is a detailed schematic diagram of a membrane-based separator; and

FIG. 6 is a detailed schematic diagram of an expansion-based separator.

### DETAILED DESCRIPTION OF THE INVENTION

The following description is provided, so as to enable any person skilled in the art to make use of said invention and sets forth the best modes contemplated by the inventor of carrying out this invention. Various modifications, however, are adapted to remain apparent to those skilled in the art, since the generic principles of the present invention have been defined specifically to provide high-temperature solid oxide fuel cell arrangement fueled by a hydrogen or hydrocarbon fuel and generating electricity and ammonia as a byproduct.

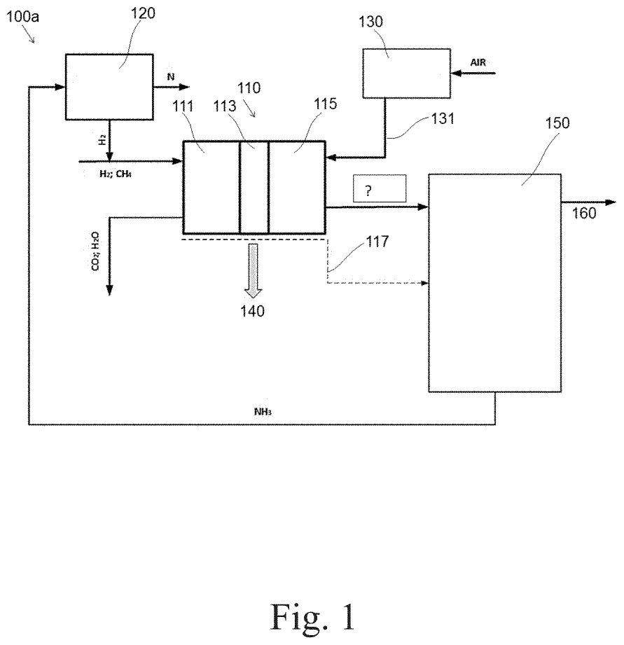

Reference is now made to FIGS. 1 to 3 presenting alternative embodiments of high-temperature solid oxide fuel cell arrangement 100a to 100c fueled by a hydrogen or hydrocarbon fuel to anode fuel cell and wet air to cathode and generating ammonia as a byproduct on cathode of fuel cell.

Referring to FIGS. 1 to 3, hydrogen or any hydrocarbon fuel is fed to anode area 111 of fuel cell 110. Concurrently, humid air generated by humidifier 130 is fed to cathode area 115 via passage 131. 113 is oxygen conductive electrolyte. The arrangements (100a, 100b and 100c) include system 150 for separation ammonia from others gases. Numeral 140 mark electric energy provided by fuel cell 110 to a load (not shown).

In arrangement 100a (FIG. 1), ammonia separated by separator 150 is fed to reformer 120 for cracking ammonia and producing hydrogen which is admixed to the fuel fed to anode area 111. Nitrogen is exhausted to the atmosphere.

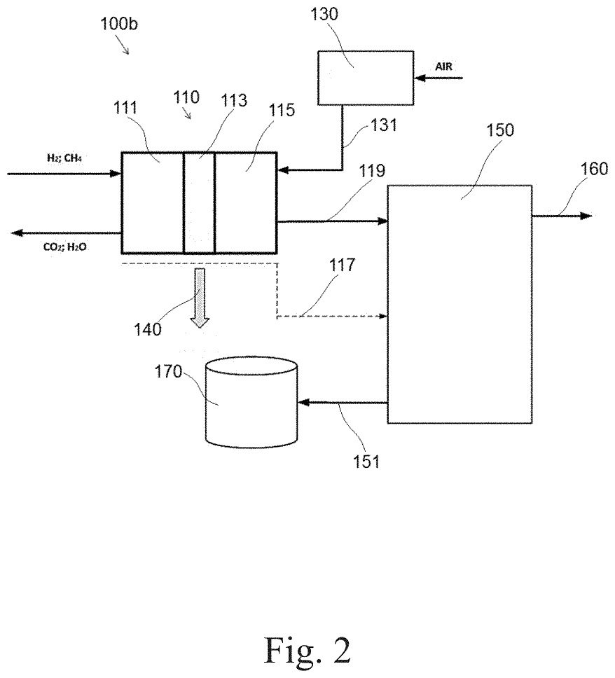

FIG. 2 illustrates embodiment 100b where separated ammonia is collected and stored in tank 170 via pipe 151.

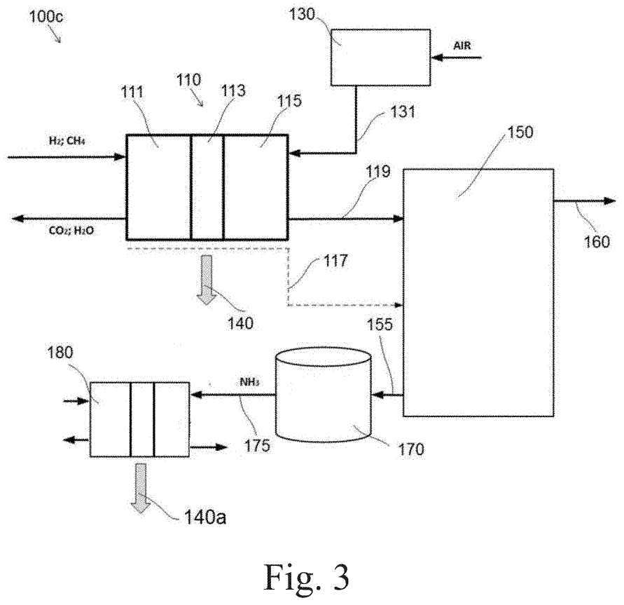

In FIG. 3, Embodiment 100c (FIG. 3) is provided with auxiliary fuel cell 180 fueled by ammonia collected and stored in tank 170 via pipe 175.

Electric energy generated by auxiliary fuel cell 180 is designated by 140a. A tail-gas stream from anode area 111 includes water vapor and carbon dioxide ( [symbol] ). A tail-gas stream from cathode area 115 includes ammonia generated within cathode area 115. The cathode tail-gas stream is fed into ammonia separator 150 via passage 119. Optionally, as disclosed below, heat generated within fuel cell 110 is transferred to ammonia separator 150, based on vaporization and dephlegmation of ammonia absorbed in water by means of heat transferring means 117.

Operation of fuel cell 10 can be schematically described by the following equations:

In case of using methane as fuel:

Cathode N₂+3H₂O+6e⁻→2NH₃+3O²⁻ (1)

O₂+4e⁻→2O²⁻ (2)

Anode CH₄+5O²⁻→CO₂+2H₂O+½O₂+10e⁻ (3)

Integral reaction CH₄+N₂+H₂O+½O₂→2NH₃+CO₂+O₂ (4)

For a hydrogen fuel cell:

Cathode N₂+3H₂O+6e⁻→2NH₃+3O²⁻ (1a)

O₂+4e⁻→2O²⁻ (2a)

Anode 5H₂+5O²⁻→5H₂O+10e⁻ (5)

Integral reaction N₂+O₂+5H₂→2NH₃+2H₂O (6)

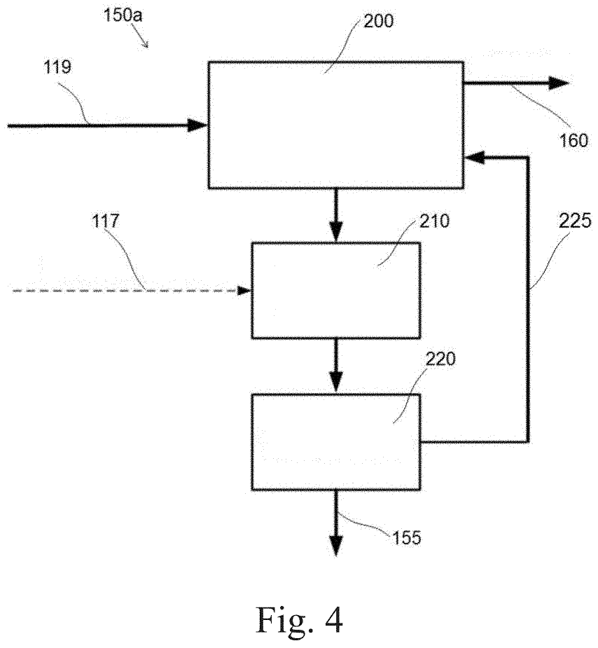

Reference is now made FIGS. 4, 5 and 6 presenting alternative embodiments 150a, 150b and 150c of ammonia separators, respectively. Embodiment 150a in FIG. 4 includes ammonia absorber 200, ammonia evaporator 210 and dephlegmator 220. Tail-gases are fed into ammonia absorber are fed via passage 119 where ammonia is absorbed in water which then fed into ammonia evaporator 210 which is heated by the heat generated by fuel cell 110 (not shown) via heat transfer means 117. The vapor generated within ammonia evaporator 210 is provided to dephlegmator 220 where ammonia and water vapor fractions are separated.

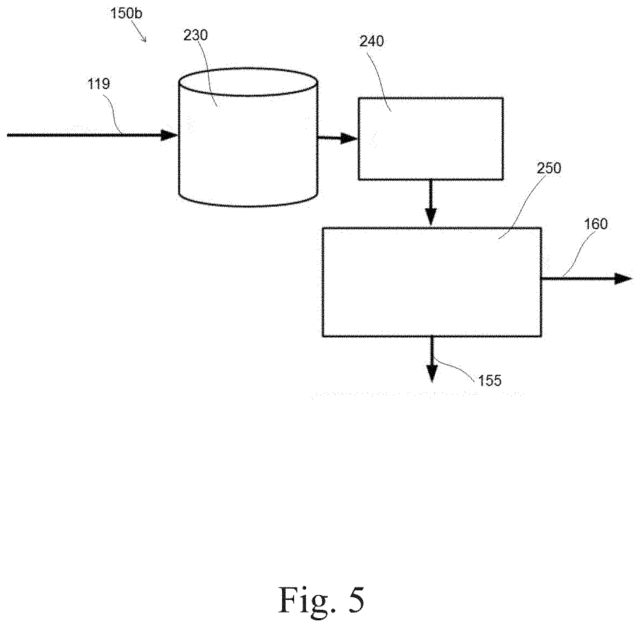

Referring to FIG. 5 showing embodiment 150b, Tail-gases via passage 119 are collected in tank 230 configured for storing exhausted tail gases. The aforesaid tail-gases are pumped by compressor 240 via membrane arrangement 250 such that ammonia 155 is separated from other exhausted gases 160.

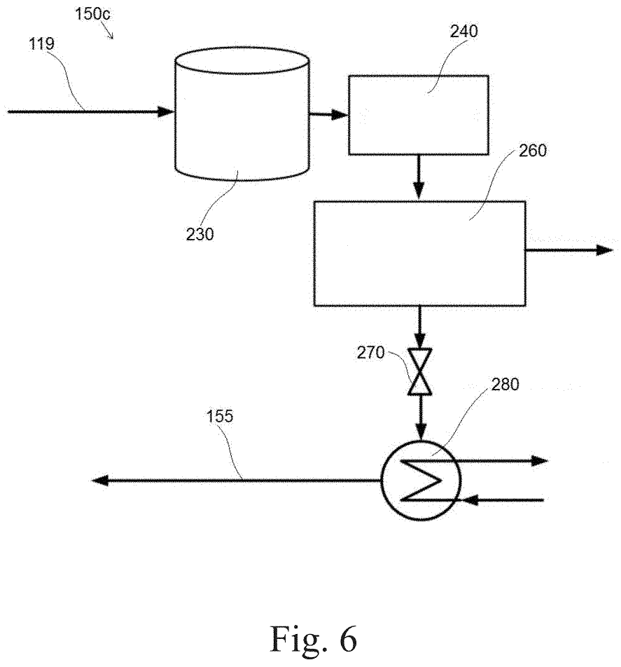

In FIG. 6, embodiment 150c is presented. Tail-gases exhausted from cathode area (not shown) are fed to tank 230 via passage 119. Tank 230 is configured for accumulating the aforesaid tail-gases. Compressor 240 is used for pressurizing the tail-gases such that ammonia is liquefied and accumulated in tank 260 while other constituents of the tail-gases are exhausted to the atmosphere. Ammonia is cooled when passes via expansion valve 270. Thereat, low-temperature gaseous ammonia can be used for cooling a working body circulating in heat-exchange arrangement 280. Further, gaseous ammonia is provided via pipe 155 to a consumer.

According to the present invention, a high-temperature solid oxide fuel cell arrangement fueled by a hydrogen or hydrocarbon fuel and generating ammonia as a byproduct is disclosed. The aforesaid fuel cell comprises: (a) a cathode area fed with a humid air; (b) an anode area fed with said fuel; (c) an oxygen-conducting electrolyte disposed between said cathode and anode areas.

It is a core purpose of the invention to provide the cathode having an ammonia-rich tail-gas stream; said fuel cell further comprises a gas separator configured for separating ammonia generated on said cathode from tail-gas stream and means for utilizing separated ammonia selected from the group consisting of: an ammonia reformer configured for generating hydrogen to be admixed to said fuel fed to said anode, a collecting tank for storing said ammonia and an auxiliary solid oxide fuel cell fueled by said separated ammonia and any combination thereof.

According to a further embodiment of the present invention, the gas separator comprises an ammonia absorber, an ammonia evaporator and a dephlegmator; said evaporator is heated by heat generated by an electrochemical reaction between cathode and anode transferred to said evaporator.

According to a further embodiment of the present invention, the gas separator comprises a compressor and a membrane arrangement. The compressor configured for pumping said tail-gasses via said membrane arrangement such that ammonia is separated from other exhausted gases.

According to a further embodiment of the present invention, the gas separator comprises a compressor configured for pressurizing the tail-gases such that ammonia is liquefied while other constituents of the tail-gases are exhausted to the atmosphere.

According to a further embodiment of the present invention, a method of generating ammonia as a byproduct by a high-temperature solid oxide fuel cell arrangement fueled by a hydrogen or hydrocarbon fuel is disclosed. The aforesaid method comprises steps of: (a) providing a high-temperature solid oxide fuel cell arrangement comprising: (i) a cathode area fed with a humid air; (ii) an anode area fed with said fuel; (iii) an oxygen-conducting electrolyte disposed between said cathode and anode areas; said cathode has an ammonia-rich tail-gas stream; said fuel cell further comprises a gas separator configured for separating ammonia generated on said cathode from tail-gas stream and means for utilizing separated ammonia selected from the group consisting of: an ammonia reformer configured for generating hydrogen to be admixed to said fuel fed to said anode, a collecting tank for storing said ammonia and an auxiliary solid oxide fuel cell fueled by said separated ammonia and any combination thereof; (b) feeding said fuel to said anode area; (c) fed humid air to said cathode area; (d) operating said fuel cell; (e) generating said ammonia as a byproduct in said cathode area; (f) separating said ammonia from said tail-gas stream; (g) utilizing separated ammonia by at least one way selected from the group consisting of reforming ammonia to hydrogen, storing ammonia in said collecting tank and fueling an auxiliary fuel cell.

According to a further embodiment of the present invention, the step of separating said ammonia from said tail-gas stream comprises heating said tail-gas stream by heat transfer means configured to transfer heat generated by said fuel cell to said ammonia gas separator.

The above-described embodiments of the present invention are intended to be examples only. Alterations, modifications and variations may be effected to the particular embodiments by those of skill in the art without departing from the scope of the invention, which is defined solely by the claims appended hereto.

1. A high-temperature solid oxide fuel cell arrangement fueled by a hydrogen or hydrocarbon fuel and generating electricity and ammonia as a byproduct; said fuel cell comprising:
a. a cathode area fed with a humid air;
b. an anode area fed with said fuel;
c. an oxygen-conducting electrolyte disposed between said cathode and anode areas;
wherein said cathode has an ammonia-rich tail-gas stream; said fuel cell further comprises a gas separator configured for separating ammonia generated on said cathode from tail-gas stream and means for utilizing separated ammonia selected from the group consisting of: an ammonia reformer configured for generating hydrogen to be admixed to said fuel fed to said anode, a collecting tank for storing said ammonia and an auxiliary solid oxide fuel cell fueled by said separated ammonia and any combination thereof.

2. The fuel cell arrangement according to claim 1, wherein said gas separator comprises a compressor and a membrane arrangement; said compressor configured for pumping said tail-gasses via said membrane arrangement such that ammonia is separated from other exhausted gases.

3. The fuel cell arrangement according to claim 1, wherein said gas separator comprises a compressor configured for pressurizing the tail-gases such that ammonia is liquefied while other constituents of the tail-gases are exhausted to the atmosphere.

4. A method of generating ammonia as a byproduct by a high-temperature solid oxide fuel cell arrangement fueled by a hydrogen or hydrocarbon fuel; said method comprising steps of:
a. providing a high-temperature solid oxide fuel cell arrangement fueled by a hydrogen or hydrocarbon fuel to anode and a cathode area fed with a humid air; said fuel cell comprising:
i. a cathode area fed with a humid air;
ii. an anode area fed with said fuel;
iii. an oxygen-conducting electrolyte disposed between said cathode and anode areas;
said cathode has an ammonia-rich tail-gas stream; said fuel cell further comprises a gas separator configured for separating ammonia generated on said cathode from tail-gas stream and means for utilizing separated ammonia selected from the group consisting of: an ammonia reformer configured for generating hydrogen to be admixed to said fuel fed to said anode, a collecting tank for storing said ammonia and an auxiliary solid oxide fuel cell fueled by said separated ammonia and any combination thereof.
b. feeding said fuel to said anode area;
c. fed humid air to said cathode area;
d. operating said fuel cell;
e. generating said ammonia as a byproduct in said cathode area;
f. separating said ammonia from said tail-gas stream;
g. utilizing separated ammonia by at least one way selected from the group consisting of reforming ammonia to hydrogen, storing ammonia in said collecting tank and fueling an auxiliary fuel cell.
